(19) United States
(12) Patent Application Publication
(10) Pub. No.: US 2005/0264561 A1
(43) Pub. Date: Dec. 1, 2005

(54) Virtual prototyping system and method

(76) Inventors: John Matthew Anast, Fairfield, OH (US); Bruce William Lavash, West Chester, OH (US); Matthew Joseph Macura, Mariemont, OH (US); Noble Lester Rye II, Liberty Twp, OH (US); Michael Lewis Rubin, Mason, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/071,916

(22) Filed: Mar. 4, 2005

Related U.S. Application Data
(60) Provisional application No. 60/550,479, filed on Mar. 5, 2004.

(51) Int. Cl. G06T 17/00

(52) U.S. Cl. 345/420

(57) ABSTRACT

A virtual model capable of simulating physical deformation of at least a portion of a body. The model comprises at least two computer-generated volumes that together define an external surface and an interfacial surface, one of the computer-generated volumes being a deformable volume and one of the computer-generated volumes being a prescribed motion volume. At least a portion of the interfacial surface has a prescribed motion associated therewith.

### CROSS REFERENCE TO RELATED APPLIATION

This application claims the benefit of U.S. Provisional Application No. 60/550,479, filed Mar. 5, 2004.

### FIELD OF THE INVENTION

The present invention relates to three-dimensional computer-aided modeling and design of garments to be worn on a body.

### BACKGROUND OF THE INVENTION

Computer simulations of motion, e.g., using FEA, have long been used to model and predict the behavior of systems, particularly dynamic systems. Such systems utilize mathematical formulations to calculate structural volumes under various conditions based on fundamental physical properties. Various methods are known to convert a known physical object into a grid, or mesh, for performing finite element analysis, and various methods are known for calculating interfacial properties, such as stress and strain, at the intersection of two or more modeled physical objects.

Use of computer simulations such as computer aided modeling in the field of garment fit analysis is known. Typically, the modeling involves creating a three-dimensional (hereinafter “3D”) representation of the body, such as a woman, and a garment, such as a woman's dress, and virtually representing a state of the garment when the garment is actually put on the body. Such systems typically rely on geometry considerations, and do not take into account basic physical laws. One such system is shown in U.S. Pat. No. 6,310,627, issued to Sakaguchi on Oct. 30, 2001.

Another field in which 3D modeling of a human body is utilized is the field of medical device development. In such modeling systems, geometry generators and mesh generators can be used to form a virtual geometric model of an anatomical feature and a geometric model of a candidate medical device. Virtual manipulation of the modeled features can be output to stress/strain analyzers for evaluation. Such a system and method are disclosed in WO 02/29758, published Apr. 11, 2002 in the names of Whirley, et al.

Further, U.S. Pat. No. 6,310,619, issued to Rice on Oct. 30, 2001, discloses a three-dimensional, virtual reality, tissue specific model of a human or animal body which provides a high level of user-interactivity.

The problem remains, however, how to model fit of a garment in both static and dynamic conditions while calculating physics-based deformations of either the body or the garment. The problem is complicated more when two deformable surfaces are interacted, such as when a soft, deformable garment is in contact with soft, deformable skin.

Accordingly, there remains a need for a system or method capable of modeling a soft, deformable garment while worn on a soft deformable body consistent with fundamental laws of physics.

Further, there remains a need for a system or method capable of modeling a soft, deformable garment while worn on a soft deformable body under dynamic conditions, such as walking or the act of sitting that simulates real stress/strain behavior.

Finally, there remains a need for a system or method capable of modeling a soft, deformable garment while worn on a soft deformable body under dynamic conditions that is not overly computer-time intensive; that is, it does not require such time and computing capability as to make it effectively un-usable for routine design tasks.

### SUMMARY OF THE INVENTION

A virtual model capable of simulating physical deformation of at least a portion of a body is disclosed. The model comprises at least two computer-generated volumes that together define an external surface and an interfacial surface, one of the computer-generated volumes being a deformable volume and one of the computer-generated volumes being a prescribed motion volume. At least a portion of the interfacial surface has a prescribed motion associated therewith.

### BRIEF DESCRIPTION OF THE DRAWINGS

FIG. 1 is a flow chart depicting schematically one embodiment of a system of the present invention.

FIG. 2 is a depiction of a point cloud.

FIG. 3 is a schematic representation of two defined volumes.

FIG. 4 is another schematic representation of two defined volumes.

FIG. 5 is a meshed, three-dimensional model of a portion of a body.

FIG. 6 is a meshed, three-dimensional model of a garment to be virtually prototyped by the system and method of the present invention.

### DETAILED DESCRIPTION OF THE INVENTION

The virtual model of the present invention can be used to virtually model the dynamic behavior of a body, such as a human body, and the body's interaction with garments. As used herein, the term “garments” means any article or object intended for placement on or in the body and intended for temporary wear. Therefore, the term garments includes externally-worn articles, such as clothing including hats, gloves, belts, shirts, pants, skirts, dresses and the like. The term garments also includes internally-worn articles such as earplugs, hearing aids, mouth guards, and tampons. Internally-worn articles generally have externally-disposed access means for placement and removable, such as finger extensions on earplugs and strings on tampons. Some garments can be partially external and partially internal, such as earrings in pierced ears, hearing aids having externally-disposed portions, and interlabially-placed catamenial devices.

It is believed that the method and system of the present invention is best suited for designing garments intended for close body contact, such as shoes, gloves, brassieres and other intimate garments. In a preferred embodiment of the present invention a three-dimensional, virtual body is utilized to model the crotch region of a human woman and a sanitary napkin garment. The invention is not limited to such a person or garment, however, and it may be used for modeling the interaction of any garment/body interface, particularly under dynamic conditions. In the present invention, whether externally-worn, internally-worn, or a combination thereof, virtual modeling is used to simulate wear based on fundamental physical laws.

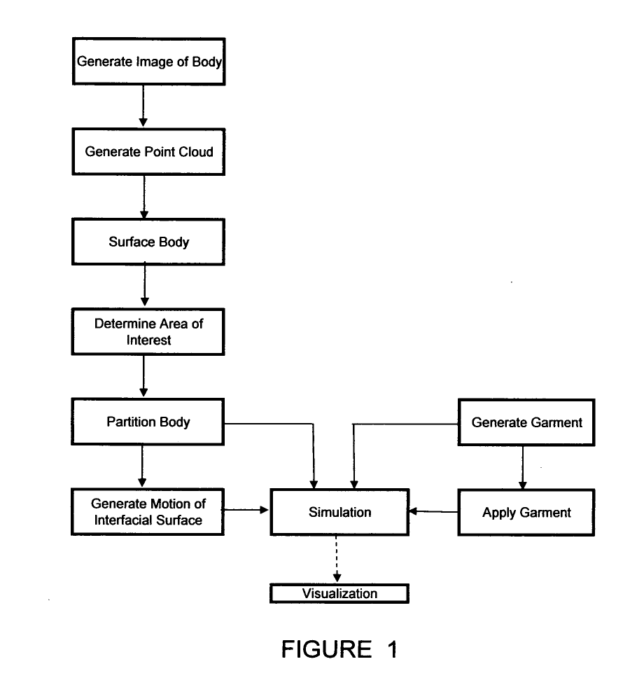

The invention can be understood by following the steps discussed below in conjunction with the flowchart in FIG. 1. The flowchart of FIG. 1 depicts elements associated with the virtual model of the invention, starting with the step of generating an image of a body, or a portion of a body to be surfaced. Surfacing is a technique for rendering a computer generated three-dimensional (3D) image of an actual 3D object. In one embodiment the portion of the body to be surfaced is the waist region of a human, including the crotch area and pudendal region, of an adult female. In another embodiment, the waist region is the waist region of an infant, useful for modeling disposable diapers. If the model is to be used to model a garment, the surfaced portion of the body includes that which is to be modeled with a garment.

Surfacing of a body can be achieved by means known in the art, such as by imaging the external surface of a portion of a body by making a series of images of the desired portion of the body using surface digital imaging techniques. However, in a preferred embodiment, surfacing of portions of a human body can be achieved by imaging techniques that also capture internal portions, such as magnetic resonance imaging (MRI). Other techniques for obtaining suitable images for surfacing could be used, such as ultrasound imaging or x-ray imaging, but MRI scans have been found to be preferred in the present invention.

The resolution of the MRI images will determine the level of detail available for analysis of fit. Therefore, the MRI scan should have sufficient resolution, including a sufficient number of “slices,” to capture anatomical features relevant to fit and comfort for the garment being modeled. The term “slices” is used in its ordinary sense with respect to MRI scans, and denotes the two-dimensional images produced by MRI imaging. In one embodiment, coronal slices of the waist region of an adult female were imaged with a 2 mm (1:1 scale) increment resolution using a GE Medical Systems Genesis Sigma 1.5 Echo Speed LX MRI unit. The data output can be a series of DICOM image files that can be exported for further evaluation and analysis. The DICOM image files can have multiple regions corresponding to various components or tissues of the body. For example, each slice of an MRI image may show regions of fat, skin, muscle, bone, internal organs, and the like. For the purposes of the preferred embodiment of a sanitary napkin, the regions of skin, fat and muscle in the pudendal region are of the most interest.

A point cloud representation can be made from the DICOM image files. On each slice of MRI images, the various regions, and the interface between regions can be located and designated by a series of points which can be identified and designated by either the software or manually by the user. The points so designated create a point cloud representation of each slice of MRI image. The number, concentration, and spacing of the points can be chosen to get sufficient resolution for the body portion being modeled, such as sufficient resolution to capture the undulations of tissues, e.g., the skin, in the various regions. In general, the number of points and their spacing should be such that relevant body portions are accurately represented to a sufficient resolution relevant to fit and comfort. In one embodiment, a distance of about 2 mm (1:1 scale) between points of the point cloud was found to provide sufficient resolution for analyzing fit and comfort of a garment worn on a body.

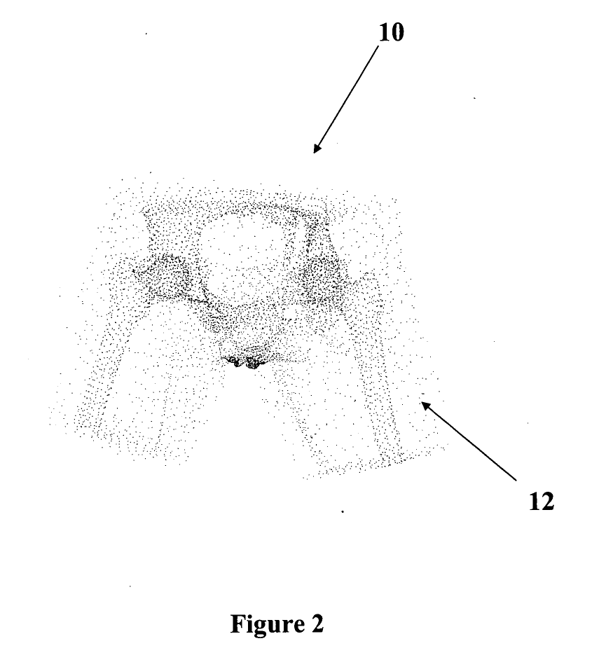

Once the points on each two-dimensional MRI slice are placed, software, such as the sliceOmatic® software referred to above, can generate a three-dimensional point cloud based on the relative position of the MRI slices. Once the three-dimensional point cloud is obtained, the data can be stored in electronic format in a variety of file types. For example, the point cloud can include a polygonal mesh in which the points are connected and the point cloud can be saved as a polygonal mesh file, such as a stereolithography file, that can be exported for further evaluation and analysis. An example of a visual rendering of a 3D point cloud 12 for the waist and crotch region 10 of a human female is shown in FIG. 2.

The point cloud of the body portion can then be surfaced by utilizing suitable software, including most computer aided design (CAD) software packages, such as, for example, Geomagic® available from Raindrop Geomagic (Research Triangle Park, N.C.). Surfacing can also be achieved by any of various means known in the art, including manually, if desired. In a preferred embodiment particular regions of the body can be surfaced, such as the interface between fat and muscle, fat and skin, and/or muscle and bone.

Once the body portion of interest is surfaced, the specific body portion of interest to be modeled is determined. For example, when modeling sanitary napkin garments, the body portion surfaced may be the entire waist and crotch region of an adult female, while the body portion of interest to be modeled is the pudendal region. The body portion of interest to be modeled is the portion of the body in which deformations are to be measured to model comfort and fit.

After determining the body portion of interest to be modeled, the surfaced portion can be arbitrarily partitioned into at least two volumes to isolate in one volume the body portion of interest to be modeled, i.e., portion of the body that is to remain deformable during modeling based on physics-based criteria. The remainder of the surfaced volume can simply be modeled by prescribed motion, thereby conserving resources in computing time. In a preferred embodiment, the surfaced body is partitioned into two separate, non-intersecting volumes, including at least a first deformable volume, and at least a second a prescribed motion volume. By “deformable volume” is meant a volume in which, when the simulation is performed, e.g., via finite element analysis (FEA), physical behavior, e.g., stress, deformation and motion, are computed. Conversely, by “prescribed motion volume” is meant a volume in which the deformations and motions are dictated by input to the simulation, and are not computational outputs of the simulation.

The prescribed motion volume is used to ensure realistic garment fit and positioning, but otherwise can have little impact on the physics-based analysis of body fit and comfort for the garment under evaluation. That is, the prescribed motion volume represents areas in which the garment may or may not interact with the wearer, or, where interaction is of lesser interest for a particular fit analysis. In general, the extent of the prescribed motion volume, and, likewise, the deformable volume, can be varied to obtain optimum results, depending on the specific garment being analyzed. For example, in the preferred embodiment of a sanitary napkin, the portion of the body corresponding to the pudendal region of a female, including interior anatomical features, can be rendered deformable as one volume, while the remaining portions of the body are rendered as a separate, non-deformable volume.

By “non-intersecting” with respect to the two volumes of the preferred embodiment is meant that the volumes do not overlap, i.e., no portion of the modeled body consists of both the deformable volume and the prescribed motion volume, but the two volumes are distinctly partitioned. In one embodiment, only the deformable volume need be determined, and then, by definition, the remainder of the body portion to be modeled represents the prescribed motion volume. The two volumes can share a common surface interface, which is all or a portion of their respective surfaces shared between the two volumes.

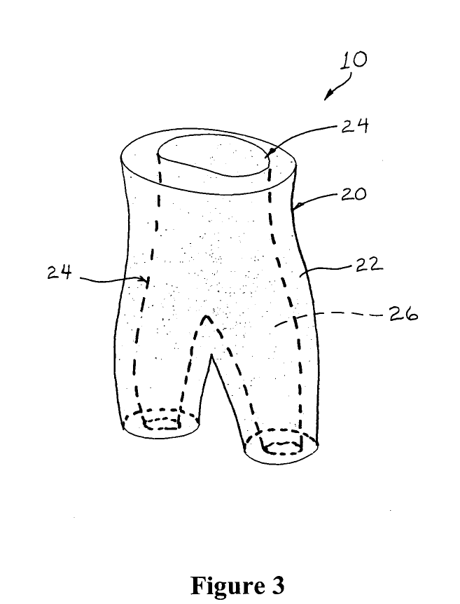

As shown in FIG. 3, interfacial surface 24 can be fully interior to the surfaced body portion 12, i.e., a surface defined as being a certain distance “in,” so to speak, from the external surface 20. The distance “in” should be great enough so as to allow for the external surface 20 to be deformable when modeled. Further, the interfacial surface should be in sufficient proximity to the external surface so as to be capable of driving motion of at least a portion of the external surface. In the embodiment shown in FIG. 3, interfacial surface 24 defines prescribed motion volume 26 which is “inside” deformable volume 22 and forms no part of the external surface 20 except at the cross-sections of the body portion 12.

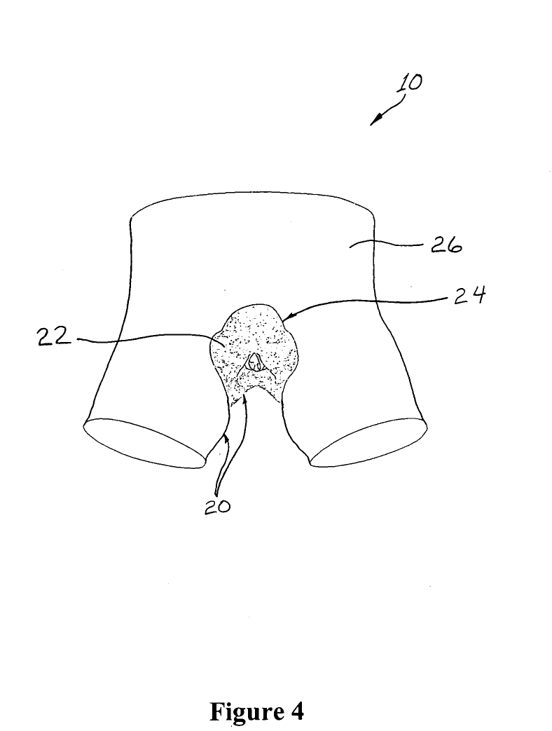

As shown in FIG. 4, interfacial surface 24 can extend to and be partially bounded by a portion of the external surface 20. In FIG. 4, deformable volume 22 and prescribed motion volume 26 meet at interfacial surface 24 that extends to external surface 20. FIG. 4 shows two volumes that have been found to be useful for modeling feminine hygiene devices, such as sanitary napkins. As shown, a deformable volume 22 corresponds to the body portion of interest to be modeled, in this case the pudendal region of an adult female for evaluation of a sanitary napkin garment. Likewise, a prescribed motion volume 26 corresponds to the portions of the body not of interest for comfort and fit of the sanitary napkin, but helpful to understand and simulate overall body movement.

After partitioning into volumes is complete, the surfaced and partitioned body portion(s) can be meshed. From the surfacing software, such as Geomagic®, the surfaces can be imported into software capable of rendering the surfaces in three dimensions, such as I-DEAS® available from UGSPLM Solutions, a subsidiary of Electronic Data Systems Corporation (Plano, Tex.), through an IGES file format. Using I-DEAS®, the surfaces are used to generate 3D renderings defining corresponding separate components corresponding to the tissues in the portions of the body to be analyzed, for example the fat, muscle, and bone. To generate these 3D renderings, the technique of volume rendering from surfaces can be used as is commonly known in the art.

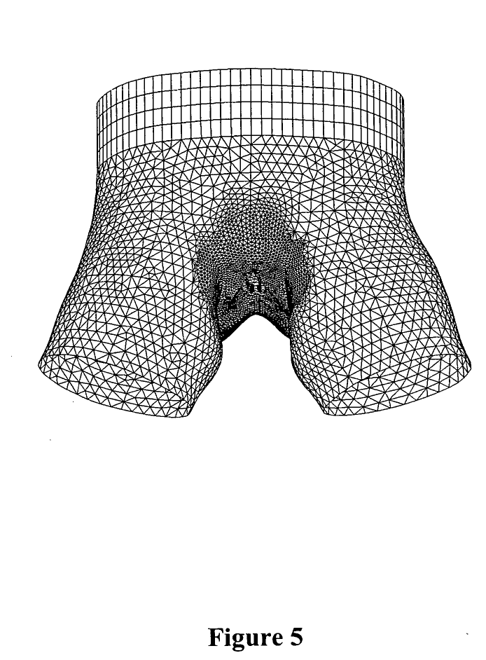

The defined volumes can be meshed separately into a mesh of nodes and elements by means known in the art. For example, meshes can be created containing solid elements, shell elements, or beam elements. In a preferred method of the present invention, the deformable volume is meshed as solid elements as shown in FIG. 5. Various tissues within the deformable volume, such as fat tissues, muscle tissues, and the like can be meshed into separate parts, and each part can have appropriate material properties assigned to it, while maintaining the continuity of the mesh. As shown in FIG. 5, the body portion of interest, which is generally part of the deformable volume, can be meshed with a greater density of nodes and elements.

The prescribed motion volume may be meshed as shell elements or solid elements, or no mesh at all, at least in some portions. The prescribed motion volume need only be meshed sufficiently to enable realistic garment positioning, in both static and dynamic conditions. Having the two volumes with different mesh properties allows for a significant reduction in the number of nodes and elements necessary to simulate the body portion of interest. Those skilled in the art will recognize that minimizing the number of nodes and elements directly correlates with reducing the cost of the simulation.

To do motion simulation and fit modeling it is necessary that motion of the body portion being modeled be driven, i.e., moved through space in time. In the present invention, motion is driven by driving at least portions of the interfacial surface. Since the deformable volume is subject to physics based constraints, driving the interfacial surface in turn drives motion of the deformable volume that is free to move and deform, with the deformations producing measurable stress and strain. The prescribed motion volume, as its name suggests, follows motion curves consistent with the motion of the interfacial surface.

The measurable stress and strain can be due to contact with the garment being modeled. Moreover, a series of garments can be tested in sequence by using the same partitioned body portion, thereby enabling multiple garments to be relatively quickly tested for fit or comfort.

The interfacial surface is driven along predetermined motion curves in space and time. The predetermined motion curves can be generated by use of external motion capture or by manually selecting and inputting a series of points in space and time. In another embodiment, the predetermined motion curves are produced from kinematic animations using animation software, for example Maya® from Alias Wavefront. In a kinematic animation a kinematic skeleton can be created and attached to the interfacial surface. The user can then prescribe the motion of the kinematic skeleton through time. The animation software uses the prescribed kinematic motion to drive the motion of the interfacial surface. Finally, the time dependent motion can be exported for all or a portion of the nodes on the interfacial surface. That is, the motion curves can be assigned to only portions of the interfacial surface.

The garment to be evaluated in the virtual model of the present invention can be generated by producing a computer aided design (CAD) geometry of the actual garment of interest. CAD geometries can be produced from CAD drawings, as is known in the art. Once the CAD geometry is produced, it can be meshed into a mesh of nodes and elements by means known in the art. The number of nodes and elements can be varied as necessary or desired for adequate garment modeling.

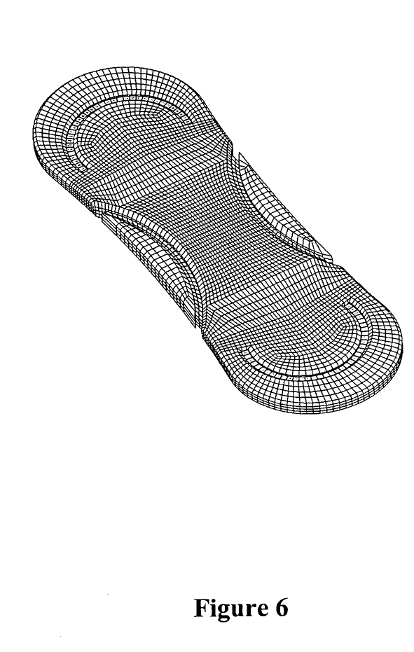

In one embodiment, the garment is a sanitary napkin intended to be worn against the body of an adult woman as shown in FIG. 6, which shows a meshed sanitary napkin garment. In most cases the sanitary napkin is worn inside the undergarment, such as elasticized panties. Therefore, in one embodiment of the present invention, the garment can actually be a garment system comprised of two or more garments interacting during wear. For example, certain sports equipment, such as shoulder pads and jerseys can be analyzed for fit and comfort as a multiple garment system. Likewise, the interaction between shoes and socks can be analyzed.

The garment can be comprised of more than one structural component, and each component can be created as a separate part and meshed independently. This enables individual material properties to be assigned to each component. For example, a woman's undergarment can have at least three components: the overall panty fabric, the crotch fabric, and the elastic strands. Each of these components can be created as separate parts with individualized material properties appropriate for each material. The material properties can be revised by the user as necessary for different garments.

The garment can be modeled in various initial states, such as in a relaxed, undeformed state, or in a non-relaxed or deformed state. For example, a sanitary napkin can be initially modeled in a generally flat, undeformed initial state, as shown in FIG. 6, or it can be initially modeled in a bunched, folded state. In one embodiment, a garment is initially modeled by having the fewest number of components initially stressed. For example, sanitary napkin can be modeled in a flat-out, undeformed configuration.

Predetermined fixed points on the meshed garment, or garment system, can be identified, the fixed points being fixed in space or with respect to the meshed body during fit analysis according to the present invention. In general, the fixed points can be a maximum distance from the deformable volume of the meshed body.

The fixed points aid in the garment being “applied” to the meshed body by using motion curves to prescribe motion to the fixed points such that the fixed points are translated from a first initial modeled position to a second fixed position relative to the meshed body. To simulate fit and comfort of the garment and body, respectively, the garment or garment system is first “applied” as described above. At this point, the simulation can calculate stresses and strains associated with fit prior to body motion. By driving motion of the body through the predetermined motion curves of the interfacial surface, dynamic stress-strain calculations on the deformable volume and garment or garment system can be made and correlated with dynamic fit and comfort.

Fit and comfort analysis can be achieved by use of a dynamic stress-strain analyzer, such as, for example, LS-DYNA® (Livermore Software Technology Corporation, Livermore, Calif.), ABAQUS® (ABAQUS Inc., Pawtucket, R.I.), or, ANSYS® (ANSYS Inc., Canonsburg, Pa.). Any desired inputs, such as body mesh motion, garment mesh motion, contact surfaces, garment mesh, and/or body mesh can be inputted to accomplish the analysis. The stress-strain analyzer supplies an output of deformed motion and corresponding forces, such as stress and strain. The forces include forces associated with deforming both the body and the garment. Garment deformation and the magnitude of the forces required to generate the deformation can be correlated to fit and comfort.

Optionally, the simulation output, such as deformations and forces can also be visualized using software such as LS-PREPOST® (Livermore Software Technology Corporation, Livermore, Calif.), Hyperview® (Altair Engineering, Troy, Mich.), Ensight® (Computational Engineering International, Apex, N.C.), or ABAQUS VIEWER® (ABAQUS Inc., Pawtucket, R.I.), for example. Visualization of the garment as the body portion is manipulated can show in visual representation the deformation of the garment. For example, a sanitary napkin can undergo buckling, twisting, and bunching during wear. Such deformation is difficult, if not impossible, to watch in real time on a real person due to the practical constraints of such a system. However, such pad fit characteristics can be easily visualized and manipulated in the computer simulation. This capability significantly reduces the time and expense of designing better fitting garments such as sanitary napkins. Properties of materials can be changed as desired and inputted through the dynamic stress-strain analyzer to change the characteristics of the garment, thereby providing for virtual prototyping of various designs.

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A virtual model capable of simulating physical deformation of at least a portion of a body, said model comprising at least two computer-generated volumes that together define an external surface and an interfacial surface, one of said computer-generated volumes being a deformable volume and one of said computer-generated volumes being a prescribed motion volume, at least a portion of said interfacial surface having a prescribed motion associated therewith.

2. The model of claim 1, further being capable of simulating physical deformation of at least a portion of garment.

3. The model of claim 1, wherein said deformable volume comprises a plurality of regions identified by material property, and said regions can differ in material property.

4. The model of claim 1, wherein said model further comprises a computer-generated garment.

5. The model of claim 4, wherein said garment is applied by one of the following: a predetermined translation of points, a predetermined application of forces, by translating said predetermined fixed points to corresponding portions of said body, and combinations thereof.

6. The model of claim 5, wherein said deformable surface and said garment can be analyzed for stress and strain while the interfacial surface is driven in a prescribed motion.

7. The model of claim 4, wherein the garment is an externally-worn article.

8. The model of claim 4, wherein the garment is a diaper.

9. The model of claim 4, wherein the garment is a sanitary napkin.

10. The model of claim 4, wherein the garment is an internally-worn article.

11. The model of claim 4, wherein the garment is a tampon.

12. The model of claim 4, wherein the garment is a medical device worn external to the body.

13. A computer-implemented system for analyzing stresses on a virtual model of a portion of a human body and a garment worn adjacent to said body, said system comprising:
a. a computer readable memory device containing data and instructions for modeling said garment on a said portion of a human body, wherein said portion of a human body comprises at least two computer-generated volumes defining an exterior surface and an interfacial surface, one of said computer-generated volumes being a deformable volume and one of said computer-generated volumes being a prescribed motion volume, and said garment comprises a computer-generated deformable surface defining a garment volume;
b. said instructions including animation of said model via virtual movement of said interfacial surface and said external surface; and,
c. a user input device for modifying said data and instructions.

14. The computer-implemented system of claim 13, wherein said instructions comprise computation of the motion of said interfacial surface from motion capture of an external body surface.

15. The computer-implemented system of claim 13, wherein said stresses being analyzed are motion-induced stresses.

16. A method of analyzing garment behavior, the method comprising:
a. creating images of a body by a method selected from the group consisting of MRI, ultrasound, X-ray, and digital imaging;
b. generating point cloud data from said images;
c. generating a surfaced body from said point cloud data;
d. generating a virtual body model capable of simulating physical deformation of at least a portion of a body from said surfaced body;
e. creating a virtual model of a garment;
f. interacting the virtual body model and virtual garment model;
g. analyzing the virtual garment behavior to determine the performance of one or more of the virtual body or virtual garment models.

17. The method of claim 16, wherein said garment is applied by means selected from one of the following: a predetermined translation of points, a predetermined application of forces, by translating said predetermined fixed points to corresponding portions of said body, and combinations thereof.

18. The method of claim 16, wherein the garment is an externally-worn article.

19. The method of claim 16, wherein the garment is a diaper.

20. The method of claim 16, wherein the garment is a sanitary napkin.

21. The method of claim 16, wherein the garment is an internally-worn article.

22. The method of claim 16, wherein the garment is a tampon.

23. The method of claim 16, wherein the garment is a medical device worn external to the body.
